(19) United States
(12) Patent Application Publication
(10) Pub. No.: US 2024/0241632 A1
(43) Pub. Date: Jul. 18, 2024

(54) INFORMATION PRESENTATION METHOD, INFORMATION PRESENTATION DEVICE, AND INFORMATION PRESENTATION PROGRAM

(71) Applicant: NIPPON TELEGRAPH AND TELEPHONE CORPORATION, Tokyo (JP)

(72) Inventors: Mitsuhiro GOTO, Musashino-shi, Tokyo (JP); Hitoshi SESHIMO, Musashino-shi, Tokyo (JP)

(73) Assignee: NIPPON TELEGRAPH AND TELEPHONE CORPORATION, Tokyo (JP)

(21) Appl. No.: 18/576,104

(22) PCT Filed: Jul. 5, 2021
(86) PCT No.: PCT/JP2021/025316

§ 371 Date: Jan. 3, 2024

(51) Int. Cl. G06F 3/04847

(52) U.S. Cl. CPC G06F 3/04847

(57) ABSTRACT

An information presentation method includes: a step of acquiring a scenario of a presentation; a step of acquiring an operation content for the scenario; a step of determining an execution scenario on the basis of the scenario and the operation content; a step of outputting an instruction for an action according to the execution scenario to a proxy device; and a step of outputting a display instruction for causing a scenario operation device to display a current execution content of the execution scenario.

### TECHNICAL FIELD

An embodiment of the present invention relates to an information presentation method, an information presentation device, and an information presentation program.

### BACKGROUND ART

Presentation is important in one-use-case exhibition or meeting of digital workers. For a highly appealing presentation, it is necessary to repeat rehearsal before actual presentation and to brush up the presentation while finding a point to be improved.

As one method of brush-up, there is a method in which a rehearsal presentation is recorded by a video camera or the like, and the recorded presentation is viewed by a user oneself to find a point to be improved.

In this method, there are many cases where the user feels that a tone and an action of the user are far from the user s own recognition. In such a case, the user cannot directly look at one's own actual behavior, and it is difficult to look back objectively.

Non Patent Literature 1 discloses a technique of visualizing a presentation situation with an avatar, performing real-time diagnosis regarding relatively simple actions such as a face direction and speech speed, and presenting points to be improved for the face direction and speech speed. In this technique, only simple actions are expressed numerically, and complex gesture actions are not diagnosis targets.

### CITATION LIST

### Non Patent Literature

Non Patent Literature 1: Jan Schneider, Dirk Borner, Peter van Rosmalen and Marcus Specht, “Presentation Trainer, your Public Speaking Multimodal Coach”, Proceedings of the 2015 ACM on International Conference on Multimodal Interaction (pp. 539-546)

### SUMMARY OF INVENTION

### Technical Problem

The present invention has been made in view of the above circumstances, and an object of the present invention is to provide an information presentation method, an information presentation device, and an information presentation program capable of prompting a user to objectively look back on a presentation.

### Solution to Problem

An information presentation method according to an aspect of the present invention is an information presentation method for presenting information to a proxy device that performs a presentation as proxy and a scenario operation device for operating a scenario of the presentation, the information presentation method including: a step of acquiring the scenario; a step of acquiring an operation content for the scenario; a step of determining an execution scenario on the basis of the scenario and the operation content; a step of outputting an instruction for an action according to the execution scenario to the proxy device; and a step of outputting a display instruction for causing the scenario operation device to display a current execution content of the execution scenario.

An information presentation device according to an aspect of the present invention is an information presentation device that presents information to a proxy device that performs a presentation as proxy and a scenario operation device for operating a scenario of the presentation, the information presentation device including: a scenario acquisition unit that acquires the scenario; an operation content acquisition unit that acquires an operation content for the scenario; an execution scenario determination unit that determines an execution scenario on the basis of the scenario and the operation content; an instruction output unit that outputs an instruction for an action according to the execution scenario to the proxy device; and an operation result output unit that outputs a display instruction for causing the scenario operation device to display a current execution content of the execution scenario.

An information presentation program according to an aspect of the present invention is a program causing a computer to execute processing of the information presentation method.

### Advantageous Effects of Invention

According to the present invention, there are provided an information presentation method, an information presentation device, and an information presentation program capable of prompting a user to objectively look back on a presentation.

### BRIEF DESCRIPTION OF DRAWINGS

FIG. 1 is a block diagram illustrating a configuration of a system including an information presentation device according to an embodiment.

FIG. 2 is a block diagram illustrating a hardware configuration of the information presentation device according to the embodiment.

FIG. 3 is a schematic diagram illustrating an example of a proxy device illustrated in FIG. 1.

FIG. 4 is a schematic diagram illustrating another example of the proxy device illustrated in FIG. 1.

FIG. 5 is a flowchart illustrating operation of the information presentation device illustrated in FIG. 1.

FIG. 6 is a schematic diagram illustrating an example of a scenario stored in a scenario storage unit illustrated in FIG. 1.

FIG. 7 is a schematic diagram illustrating an example of data of the scenario illustrated in FIG. 6 in a tabular format.

FIG. 8 is a schematic diagram illustrating an example of an operation screen of the scenario operation device illustrated in FIG. 1.

FIG. 9 is a flowchart illustrating operation of selectively reading a slide corresponding to an execution range, which is a first stage operation of determining an execution scenario,

FIG. 10 is a schematic diagram illustrating data of a slide selectively read from the scenario storage unit in a tabular format.

FIG. 11 is a flowchart illustrating an operation of converting a non-verbal action in the slide depending on an execution level, which is a second stage operation of determining an execution scenario.

FIG. 12 is a schematic diagram illustrating an operation of determining an execution scenario in a case where the execution level is an outline reproduction level.

FIG. 13 is a schematic diagram Illustrating an operation of determining an execution scenario in a case where the execution level is an emphasis reproduction level.

FIG. 14 is a schematic diagram illustrating an example of display of the operation screen of the scenario operation device and actions of the proxy device according to the operation of the information presentation device according to the embodiment.

### DESCRIPTION OF EMBODIMENTS

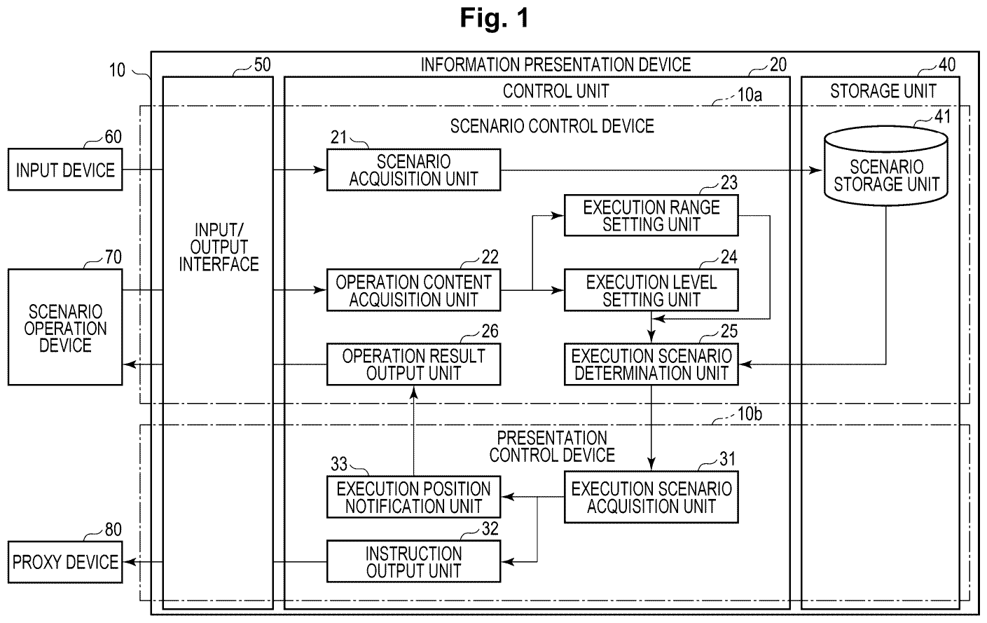

Hereinafter, an embodiment of the present invention will be described with reference to the drawings. First, a system including an information presentation device according to the embodiment will be described with reference to FIGS. 1 to 4.

### (1-1) System Configuration

FIG. 1 is a block diagram illustrating a configuration of the system including the information presentation device according to the embodiment. This system operates a scenario of a presentation for user confirmation, executes the presentation in accordance with the operated scenario, and displays a current execution content as text information.

The system includes an information presentation device 10, an input device 60 for inputting the scenario of the presentation, a scenario operation device 70 for operating the scenario, and a proxy device 80 for performing the presentation as proxy.

The input device 60 is a device for inputting the scenario of the presentation to the information presentation device 10. Generally, the scenario includes a plurality of slides. Each slide includes a verbal action and a non-verbal action. In other words, each slide includes an oral content, a slide content, and a gesture action.

The scenario operation device 70 is a device for inputting an operation content of the scenario to the information presentation device 10. The scenario operation device 70 is also a device for displaying an operation result by the information presentation device 10.

The information presentation device 10 is a device that determines an execution scenario to be executed by the proxy device 80 on the basis of the scenario input from the input device 60 and the operation content input from the scenario operation device 70, causes the proxy device 80 to execute the execution scenario, and causes the scenario operation device 70 to display the current execution content by the proxy device 80 as text information.

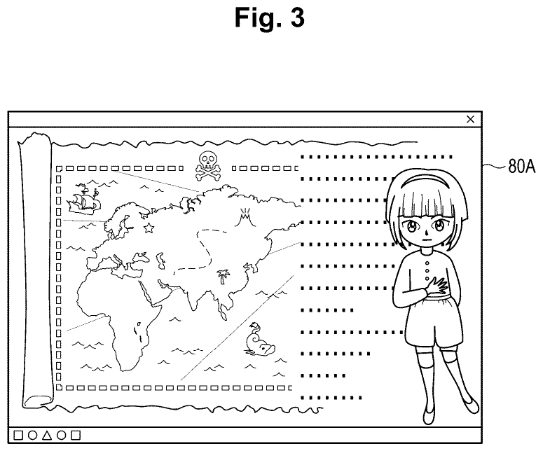

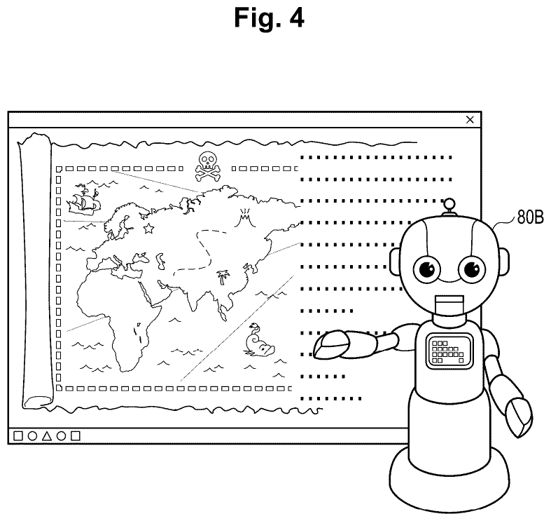

The proxy device 80 is a device that executes the presentation in accordance with the execution scenario provided from the information presentation device 10. The proxy device 80 may be any device, system, or the like as long as it can express three elements of the oral content, the slide content, and the gesture action. FIG. 3 illustrates a virtual agent 80A that executes a presentation in a virtual space as an example. In addition, FIG. 4 illustrates a robot 80B that executes a presentation in a real space as another example.

### (1-2) Functional Configuration of Information Presentation Device 10

Next, a functional configuration of the information presentation device 10 according to the embodiment will be described. As illustrated in FIG. 1, the information presentation device 10 includes a control unit 20, a storage unit 40, and an input/output interface 50.

The control unit 20 executes various operations necessary for the information presentation device 10. The control unit 20 executes an operation of acquiring the scenario, an operation of acquiring the operation content, an operation of determining the execution scenario on the basis of the scenario and the operation content, an operation of outputting an instruction for an action to be executed by the proxy device 80, and an operation of outputting a display instruction for causing the scenario operation device 70 to display the current execution content.

The storage unit 40 stores the scenario of the presentation input from the input device 60.

The input/output interface 50 inputs and outputs data between the control unit 20, and the input device 60, the scenario operation device 70, and the proxy device 80. Specifically, the input/output interface 50 inputs the scenario input from the input device 60 to the control unit 20. The input/output interface 50 inputs the operation content input from the scenario operation device 70 to the control unit 20, and outputs the operation result output from the control unit 20 to the scenario operation device 70. The input/output interface 50 outputs the execution scenario output from the control unit 20 to the proxy device 80.

When functionally divided roughly, the information presentation device 10 includes a scenario control device 10a and a presentation control device 10b. The scenario control device 10a determines the execution scenario to be executed by the proxy device 80 on the basis of the scenario input from the input device 60 and the operation content input from the scenario operation device 70. The presentation control device 10b causes the proxy device 80 to execute the execution scenario. The scenario control device 10a also causes the scenario operation device 70 to display the current execution content by the proxy device 80 as text information on the basis of an instruction and information from the presentation control device 10b.

The control unit 20 includes a scenario acquisition unit 21, an operation content acquisition unit 22, an execution range setting unit 23, an execution level setting unit 24, an execution scenario determination unit 25, and an operation result output unit 26 as functional components related to the scenario control device 10a. The control unit 20 includes an execution scenario acquisition unit 31, an instruction output unit 32, and an execution position notification unit 33 as functional components related to the presentation control device 10b. In addition, the storage unit 40 includes a scenario storage unit 41 as a functional component related to the scenario control device 10a.

The scenario acquisition unit 21 acquires the scenario of the presentation from the input device 60. In addition, the scenario acquisition unit 21 outputs the acquired scenario to the scenario storage unit 41.

The scenario storage unit 4′1 stores the scenario input from the scenario acquisition unit 21. The scenario storage unit 41 does not need to be built in the information presentation device 10, and may be connected to the information presentation device 10 via a network.

The operation content acquisition unit 22 acquires the operation content from the scenario operation device 70. The operation content includes an execution range of the scenario and a confirmation level of the scenario.

The execution range setting unit 23 acquires the execution range of the scenario from the operation content acquisition unit 22 and sets the execution range of the scenario.

The execution level setting unit 24 acquires the confirmation level of the scenario from the operation content acquisition unit 22, and sets an execution level of the scenario on the basis of the confirmation level.

The execution scenario determination unit 25 acquires the execution range of the scenario from the execution range setting unit 23, and acquires the execution level of the scenario from the execution level setting unit 24. In addition, the execution scenario determination unit 25 reads a necessary slide from the scenario storage unit 41 depending on the execution range, processes the read slide depending on the execution level, and determines the execution scenario.

The execution scenario acquisition unit. 31 acquires the execution scenario from the execution scenario determination unit 25. In addition, the execution scenario acquisition unit 31 supplies the acquired execution scenario to the instruction output unit 32 and the execution position notification unit 33.

The instruction output unit 32 outputs the instruction for the action to be executed by the proxy device 80 to the proxy device 80 on the basis of the execution scenario supplied from the execution scenario acquisition unit 31.

The execution position notification unit. 33 notifies the operation result output unit 26 of a current execution position of the execution scenario and supplies a content of the execution scenario.

The operation result output unit 26 outputs the display instruction for causing the scenario operation device 70 to display the current execution content of the execution scenario, to the scenario operation device 70.

### (1-3) Hardware Configuration of Information Presentation Device 10

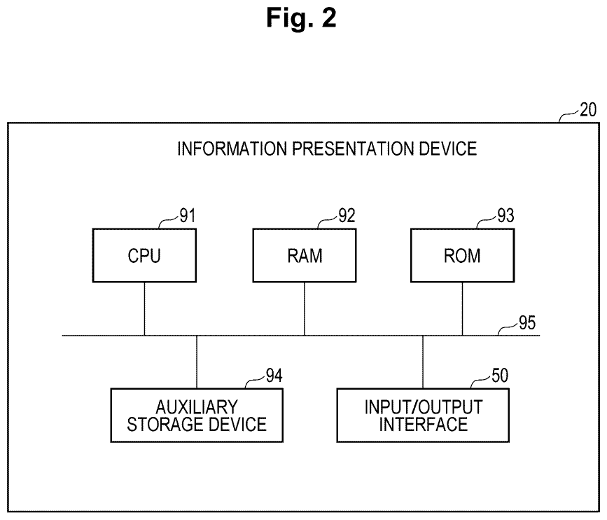

FIG. 2 is a block diagram illustrating an example of a hardware configuration of the information presentation device 10. As described above, the information presentation device 10 includes, for example, a computer. As illustrated in FIG. 2, the information presentation device 10 includes, as a hardware configuration, a central processing unit (CPU) 91, a random access memory (RAM) 92, a read only memory (ROM) 93, an auxiliary storage device 94, and the input/output interface 50. The CPU 91, the RAM 92, the ROM 93, the auxiliary storage device 94, and the input/output interface 50 are electrically connected to each other via a bus 95.

The CPU 91 is an example of a general-purpose hardware processor, and controls overall operation of the information presentation device 10.

The PAM 92 is a main storage device, and includes, for example, a volatile memory such as a synchronous dynamic random access memory (SDRAM). The RAM 92 temporarily stores a program and information necessary for processing executed by the CPU 91.

The ROM 93 non-temporarily stores a program and information necessary for basic processing performed by the CPU 91.

The CPU 91, the RAM 92, and the ROM 93 constitute the control unit 20 of the information presentation device 10.

The auxiliary storage device 94 includes, for example, a non-volatile storage medium such as a hard disk drive (HDD) or a solid state drive (SSD). The auxiliary storage device 94 constitutes the storage unit 40. That is, the auxiliary storage device 94 constitutes the scenario storage unit 41.

In addition, the auxiliary storage device 94 stores an information presentation program necessary for the operation of the information presentation device 10. The information presentation program is a program that causes the CPU 91 to execute a function of the control unit 20. That is, the information presentation program is a program that causes the CPU 91 to execute functions of the scenario acquisition unit 21, the operation content acquisition unit 22, the execution range setting unit 23, the execution level setting unit 24, the execution scenario determination unit 25, the operation result output unit 26, the execution scenario acquisition unit 31, the instruction output unit 32, and the execution position notification unit 33. For example, the information presentation program is recorded in a storage medium such as an optical disk, and is read by the auxiliary storage device 94. Alternatively, the program is stored in a server on the network and downloaded to the auxiliary storage device 94.

The CPU 91 reads the information presentation program from the auxiliary storage device 94 into the RAM 92 and executes the information presentation program, thereby operating as the scenario acquisition unit 21, the operation content acquisition unit 22, the execution range setting unit 23, the execution level setting unit 24, the execution scenario determination unit. 25, the operation result output unit 26, the execution scenario acquisition unit 31, the instruction output unit 32, and the execution position notification unit 33.

Instead of the CPU 91 and the RAM 92, an integrated circuit such as an application specific integrated circuit (ASIC) or a field-programmable gate array (FPGA) may configure the scenario acquisition unit 21, the operation content acquisition unit 22, the execution range setting unit 23, the execution level setting unit 24, the execution scenario determination unit 25, the operation result output unit 26, the execution scenario acquisition unit 31, the instruction output unit 32, and the execution position notification unit 33.

### (2-1) Operation of Information Presentation Device 10

Next, description will be given of the operation of the information presentation device 10 configured as described above. Each operation of the information presentation device 10 is executed by cooperation of the control unit 20, the storage unit 40, and the input/output interface 50. Hereinafter, description will be given focusing on each functional component of the control unit 20.

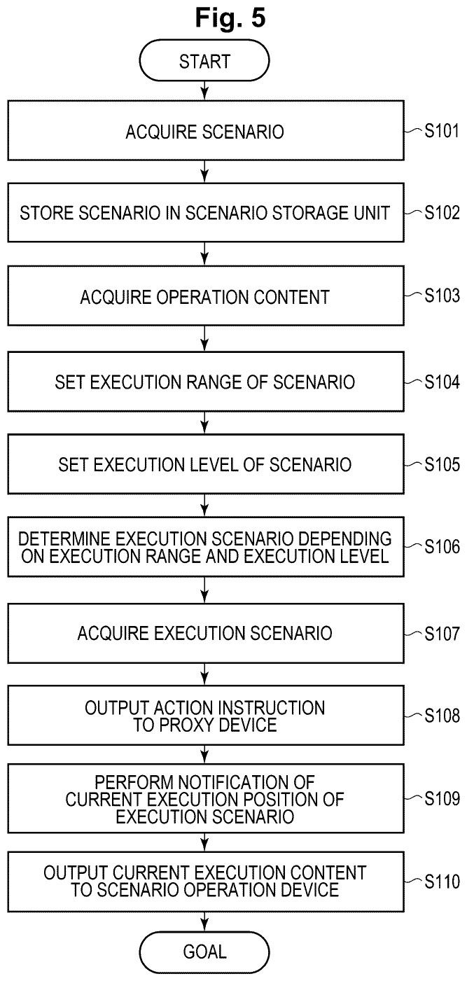

The operation of the information presentation device 10 will be described with reference to FIG. 5. FIG. 5 is a flowchart illustrating the operation of the information presentation device 10.

In step S101, the scenario acquisition unit 21 acquires the scenario of the presentation from the input device 60.

In step S102, the scenario acquisition unit 21 stores the acquired scenario in the scenario storage unit 41.

The scenario includes a plurality of slides executed in time series. Each of the plurality of slides includes an utterance content and a non-verbal action.

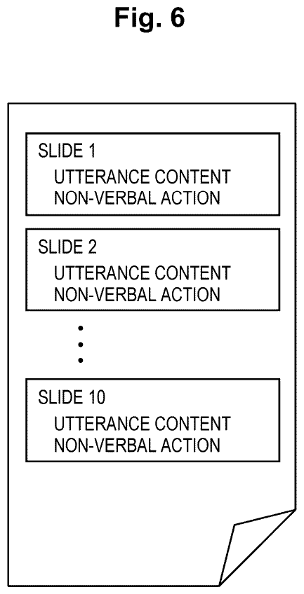

FIG. 6 is a schematic diagram illustrating an example of the scenario stored in the scenario storage unit 41. The scenario illustrated in FIG. 6 includes a slide 1, a slide 2, . . . , and a slide 10. Each of the slide 1, the slide 2, . . . , and the slide 10 includes an utterance content and a non-verbal action.

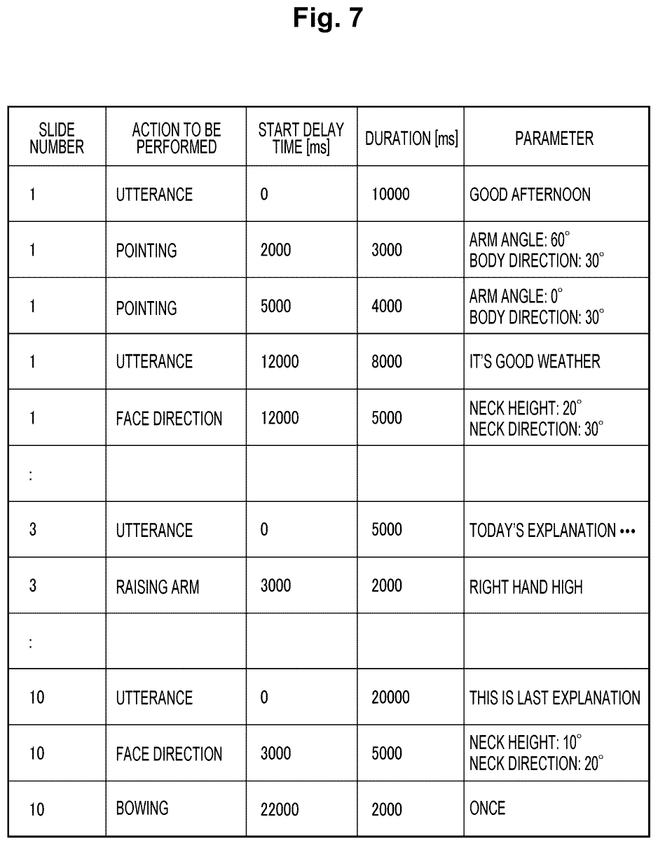

FIG. 7 is a schematic diagram illustrating an example of data of the scenario illustrated in FIG. 6 in a tabular format. As illustrated in FIG. 7, the data of the scenario includes items of a slide number, an action to be performed, a start delay time, a duration, and a parameter.

The slide number is information for identifying the plurality of slides. The action to be performed is divided into a verbal action and a non-verbal action. The verbal action includes an utterance, and the non-verbal action includes pointing, a face direction, raising an arm, bowing, and the like. The start delay time indicates a delay time of the start of an action based on the start of each slide. The duration indicates a time from the start to the end of the action. The parameter indicates information such as various settings of the action. The start delay time, the duration, and the parameter are set for each of actions to be performed.

In step S103, the operation content acquisition unit 22 acquires the operation content from the scenario operation device 70. The operation content includes an execution range of the scenario and a confirmation level of the scenario.

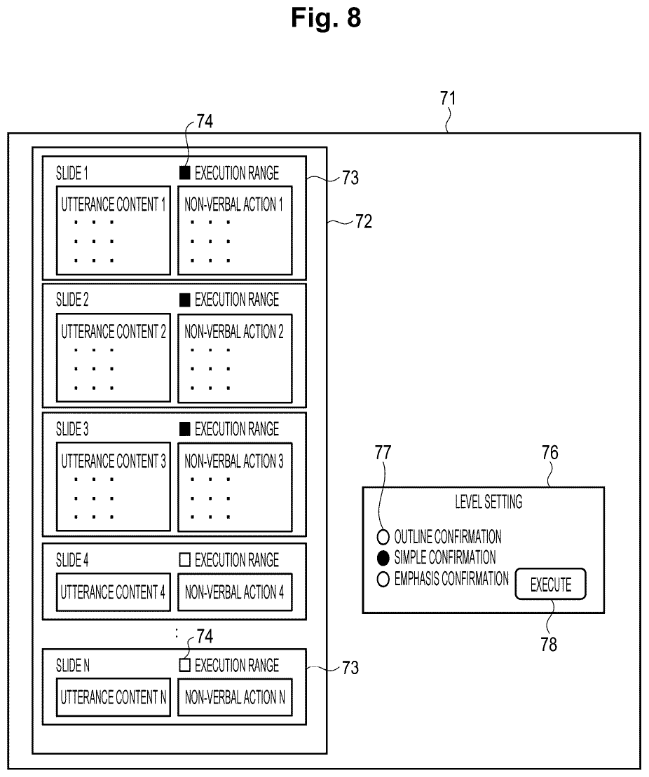

FIG. 8 is a schematic diagram illustrating an example of an operation screen 71 of the scenario operation device 70. The operation screen 71 includes an execution range setting window 72 and a confirmation level setting window 76. The execution range setting window 72 includes a plurality of slide windows 73 indicating a plurality of slides constituting the scenario.

Each slide window 73 indicates a slide number and includes a check box 74 for selecting the slide as an execution range. By setting the check box 74 to be on, it is possible to select the slide having the set check box 74 as the execution range.

In addition, in a case where the check box 74 is turned on, each slide window 73 displays details of the utterance content and the non-verbal action of the slide.

The confirmation level setting window 76 indicates three selectors of outline confirmation, simple confirmation, and emphasis confirmation, and can designate the confirmation level by selecting any one of radio buttons of these selectors.

The operation screen 71 also includes an execution button 78 for giving an instruction to start confirmation of the scenario. By operating the execution button 78, it is possible to instruct the information presentation device 10 to start confirmation of the scenario. That is, when receiving the operation of the execution button 78 by the user, the scenario operation device 70 transmits information on the instruction to start confirmation of the scenario to the operation content acquisition unit 22.

When receiving the information on the instruction to start confirmation of the scenario, the operation content acquisition unit 22 acquires information on a selection state and information on the confirmation level of each slide set on the operation screen 71 from the scenario operation device 70. That is, the operation content acquisition unit 22 acquires on/off information of the check box 74 of each slide and on/off information of all radio buttons.

In step S104, the execution range setting unit 23 acquires the information on the selection state of each slide from the operation content acquisition unit 22, and sets the execution range of the scenario on the basis of the acquired information on the selection state of each slide. That is, the execution range setting unit 23 acquires the on/off information of the check box 74 of each slide from the operation content acquisition unit 22, and sets the slide in which the check box 74 is set to be on as the execution range of the scenario.

In step S105, the execution level setting unit 24 acquires the information on the confirmation level of the scenario from the operation content acquisition unit 22, and sets the execution level of the scenario on the basis of the acquired information on the confirmation level. That is, the execution level setting unit 24 sets the execution level of the scenario to any one of a simple reproduction level at which the non-verbal action is reproduced as it is, an outline reproduction level at which only a main non-verbal action is reproduced, and an emphasis reproduction level at which a characteristic non-verbal action is emphasized and reproduced in accordance with the confirmation level designated by the radio button.

In step S106, the execution scenario determination unit 25 acquires information on the execution range of the scenario from the execution range setting unit 23, and acquires information on the execution level of the scenario from the execution level setting unit 24. In addition, the execution scenario determination unit 25 determines the execution scenario depending on the information on the execution range and the information on the execution level.

The operation of determining the execution scenario includes a first stage operation of selectively reading a slide corresponding to the execution range from the scenario storage unit 41, and a second stage operation of converting the non-verbal action in the read slide depending on the execution level. Details of these operations will be described later.

In step S107, the execution scenario acquisition unit 31 acquires the execution scenario from the execution scenario determination unit 25. In addition, the execution scenario acquisition unit 31 supplies the acquired execution scenario to the instruction output unit 32 and the execution position notification unit 33. The instruction output unit 32 and the execution position notification unit 33 operate in synchronization with each other.

In step S108, the instruction output unit 32 outputs the instruction for the action to be executed by the proxy device 80 to the proxy device 80 on the basis of the execution scenario supplied from the execution scenario acquisition unit 31. In response to this, the proxy device 80 executes the action of the execution scenario in accordance with the instruction for the action from the instruction output unit 32.

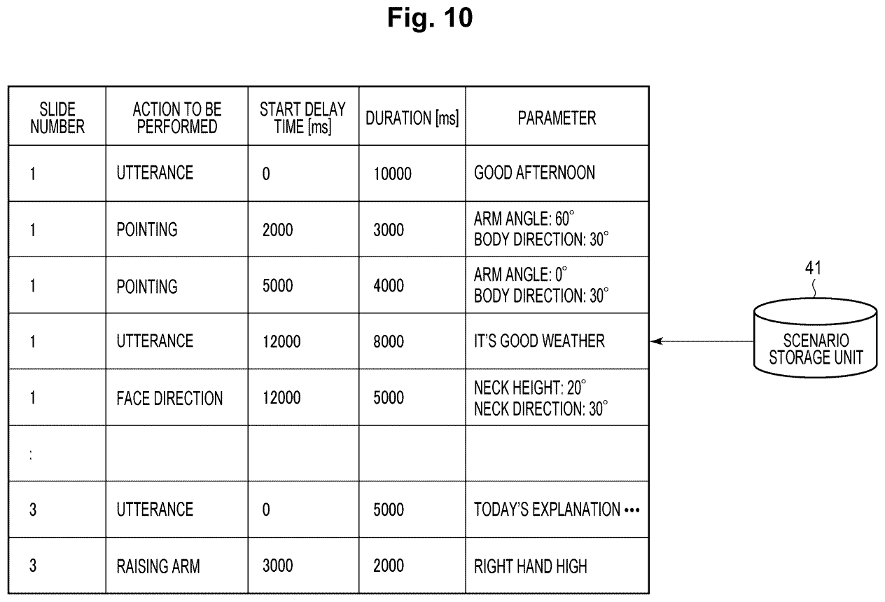

In step 3109, the execution position notification unit 33 notifies the operation result output unit 26 of the current execution position of the execution scenario. Since the execution position notification unit 33 operates in synchronization with the instruction output unit 32, it is possible to know the current execution position of the execution scenario. The execution position notification unit 33 performs notification of the execution position and also supplies the content of the execution scenario to the operation result output unit 26. The content of the execution scenario is, in an example, tabular data of the execution scenario illustrated in FIG. 10.

In step S110, the operation result output unit 26 outputs the display instruction for causing the scenario operation device 70 to display the current execution content of the execution scenario determined in accordance with the operation content from the scenario operation device 70 to the scenario operation device 70. In response to this, the scenario operation device 70 displays the current execution content of the execution scenario input from the operation result output unit 26 as text information. For example, the scenario operation device 70 displays the tabular data of the execution scenario illustrated in FIG. 10 and highlights the data of a row being executed.

### (2-2) First Stage Operation of Determining Execution Scenario

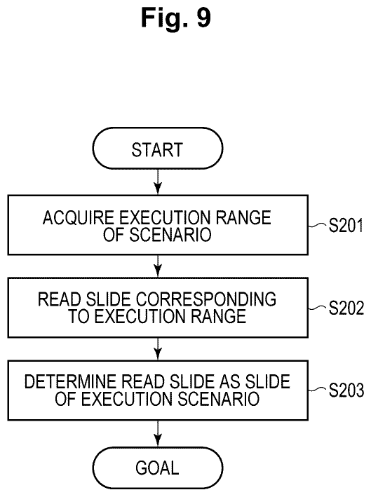

Here, a first stage operation of determining an execution scenario will be described with reference to FIG. 9. FIG. 9 is a flowchart illustrating the first stage operation or determining an execution scenario, that is, operation or selectively reading the slide corresponding to the execution range.

In step S201, the execution scenario determination unit 25 acquires the execution range set by the execution range setting unit 23.

In step S202, the execution scenario determination unit 25 selectively reads the slide corresponding to the execution range from the scenario stored in the scenario storage unit 41.

In step S203, the execution scenario determination unit 25 determines the read slide as a slide of the execution scenario.

FIG. 10 is a schematic diagram illustrating data of the slide selectively read from the scenario storage unit 41 in a tabular format. As illustrated in FIG. 10, the data of the slides read from the scenario storage unit 41 include data of the slides 1, 2, and 3 selected as the execution range on the operation screen 71 illustrated in FIG. 8.

### (2-3) Second Stage Operation of Determining Execution Scenario

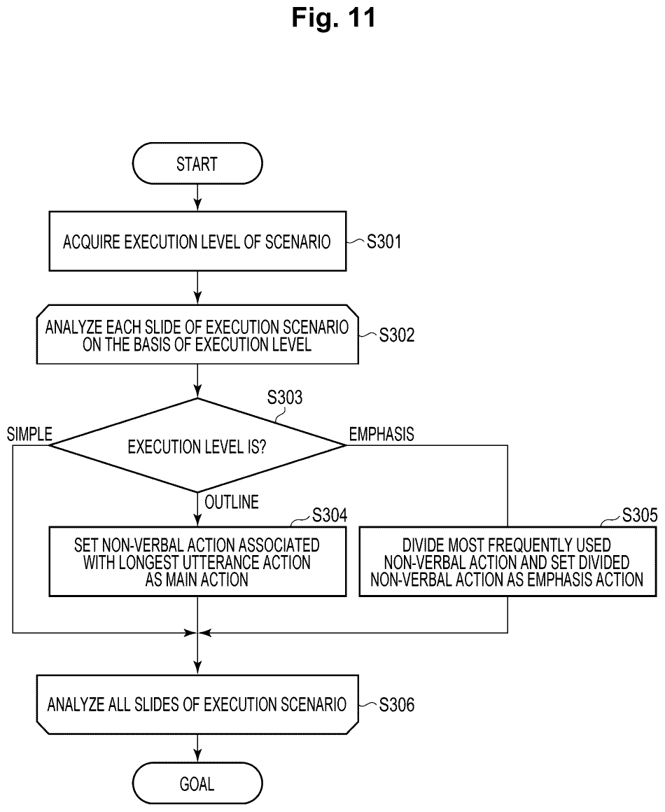

Next, the operation in the stage at which the execution scenario is determined will be described with reference to FIG. 11. FIG. 11 is a flowchart illustrating the second stage operation of determining the execution scenario, that is, the operation of converting the non-verbal action in the slide depending on the execution level.

In step S301, the execution scenario determination unit 25 acquires the execution level set by the execution level setting unit 24.

In step S302, the execution scenario determination unit 25 analyzes each slide of the execution scenario on the basis or the execution level.

In step S303, the execution scenario determination unit 25 determines the execution level. In a case where the execution level is the simple reproduction level, the processing proceeds to step S306. In a case where the execution level is the outline reproduction level, the processing proceeds to step 3304. In a case where the execution level is the emphasis reproduction level, the processing proceeds to step 3305.

In step S304, the execution scenario determination unit 25 determines the longest utterance action. The longest utterance action is determined by comparing durations of a plurality of utterance actions in the slide with each other. In a case where there is a plurality of utterance actions having the longest duration, all the utterance actions may be set as the longest utterance actions, or one of the plurality of utterance actions may be set as the longest utterance action. In that case, selection of one utterance action may be performed in accordance with a predetermined rule or may be performed randomly. Note that, in a case where there is one utterance action in the slide, the utterance action is set as the longest utterance action.

Next, the execution scenario determination unit 25 sets a non-verbal action associated with the longest utterance action as a main action. A setting condition of the main action is to be associated with the longest utterance action, and thus, there may be one or a plurality of main actions. The execution scenario determination unit 25 also deletes the non-verbal action other than the main action from the scenario. In other words, the execution scenario determination unit 25 determines the main action remaining in this way as the non-verbal action of the execution scenario.

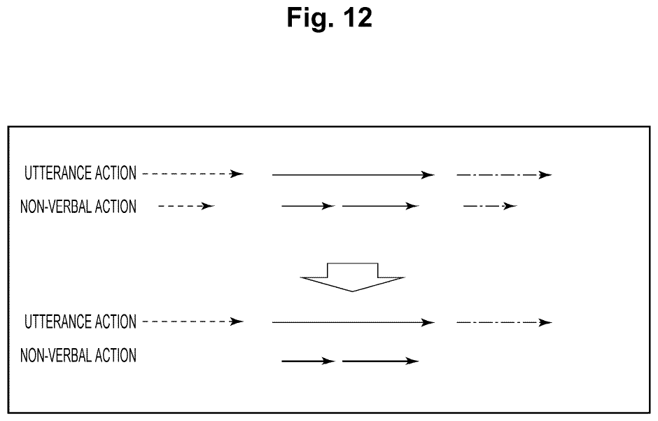

FIG. 12 is a schematic diagram illustrating an operation of converting the scenario, that is, an operation of determining the execution scenario in a case where the execution level is the outline reproduction level. FIG. 12 illustrates, on the upper side, actions in the scenario before conversion, and illustrates, on the lower side, actions in the scenario after conversion, that is, the execution scenario.

In utterance actions illustrated in the upper side of FIG. 12, an utterance action indicated by a thin solid arrow corresponds to the longest utterance action. For this reason, a non-verbal action indicated by a thin solid line associated with the utterance action indicated by the thin solid line is set as the main action. As a result, in the execution scenario illustrated in the lower side of FIG. 12, the non-verbal action indicated by the thin solid line associated with the utterance action indicated by the thin solid line remains, but the non-verbal actions indicated by a broken line and a one-dot chain line associated with other utterance actions indicated by a broken line and a one-dot chain line are deleted.

In step S305, the execution scenario determination unit 25 first determines a characteristic non-verbal action among the non-verbal actions in the slide. For example, the execution scenario determination unit 25 determines a non-verbal action most frequently used in the slide as the characteristic non-verbal action. In a case where there is a plurality of types of non-verbal actions that are most frequently used, for example, it is determined that there is no characteristic non-verbal action.

Next, the execution scenario determination unit 25 processes the characteristic non-verbal action, and sets the processed non-verbal action as an emphasis action. For example, the execution scenario determination unit 25 divides the characteristic non-verbal action into a plurality of non-verbal actions, and sets the divided non-verbal actions as emphasis actions. The execution scenario determination unit 25 does not process a non-verbal action other than the characteristic non-verbal action and leaves the non-verbal action as it is. In this way, the execution scenario determination unit 25 determines the non-verbal action of the execution scenario.

When the characteristic non-verbal action is divided into a plurality of non-verbal actions, the number of divisions is determined such that a duration of one non-verbal action after the division does not fall below a threshold. For example, in a case where the duration of the characteristic non-verbal action is 8000 ms and the threshold thereof is 1500 ms, since 8000 ms/1500 ms 5.3, the number of divisions is determined to be 5.

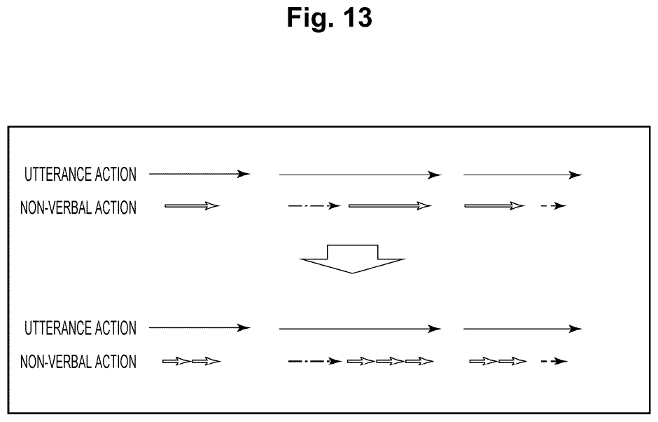

FIG. 13 is a schematic diagram illustrating an operation or converting the scenario, that is, an operation of determining the execution scenario in a case where the execution level is the emphasis reproduction level. FIG. 13 illustrates, on the upper side, actions in the scenario before conversion, and illustrates, on the lower side, actions in the scenario after conversion, that is, the execution scenario.

In non-verbal actions illustrated in the upper side of FIG. 13, a non-verbal action indicated by an outline arrow is most frequently used, and this corresponds to the characteristic action. The characteristic action is divided into a plurality of actions. In other words, the characteristic action is repeatedly executed with reduced duration. As a result, in the execution scenario illustrated in the lower side of FIG. 13, non-verbal actions indicated by a broken line and a one-dot chain line, which do not correspond to the characteristic action, are left as they are, but the characteristic action indicated by the outline arrow is divided into a plurality of actions.

In step S306, the execution scenario determination unit 25 analyzes all the slides in the execution scenario. That is, the execution scenario determination unit 25 returns to step S302 and repeatedly performs the processing of steps S303, S304, and S305 until the analysis of all the slides of the execution scenario is completed.

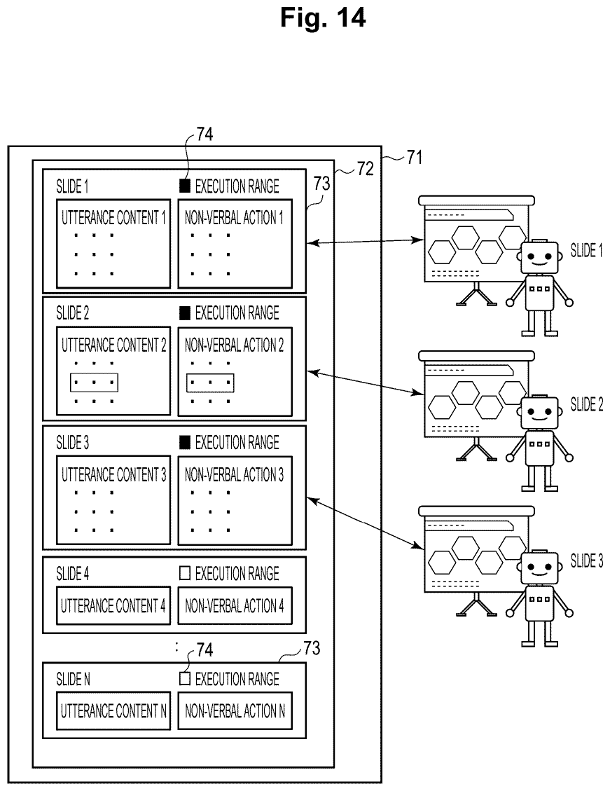

FIG. 14 is a schematic diagram illustrating an example of display of the operation screen 71 of the scenario operation device 70 and actions of the proxy device 80 according to the operation of the information presentation device 10 described above. FIG. 14 schematically illustrates a state in which the details of the utterance content and the non-verbal action of the slides 1, 2, and 3 selected as the scenario execution range are displayed as text information on the operation screen 71, and the slides 1, 2, and 3 are executed by the proxy device 80. Further, as schematically illustrated by enclosing in a square, a state is illustrated in which the text information on the utterance content and non-verbal action of the slide 2 currently being executed are highlighted.

### (3) Effects

As described above, the information presentation device 10 according to the embodiment converts the scenario of the presentation input from the input device 60 in accordance with the execution range and the confirmation level input from the scenario operation device 70 and determines the execution scenario. The information presentation device 10 causes the proxy device 80 to execute the execution scenario, and causes the scenario operation device 70 to display the current execution content by the proxy device 80 as text information.

By causing the proxy device 80 to execute the presentation, the user's sense of psychologic resistance can be reduced, and the user can objectively look back on the scenario.

In addition, by causing the scenario operation device 70 to display the details of the non-verbal action as text information, the user can confirm the details of the non-verbal action.

Thus, according to the embodiment, there are provided an information presentation method, an information presentation device, and an information presentation program capable of prompting a user to objectively look back on a presentation.

Note that the present invention is not limited to the above-described embodiment, and various modifications can be made at the implementation stage without departing from the gist of the invention. In addition, embodiments may be implemented in an appropriate combination, and in that case, a combined effect is obtained. Furthermore, the embodiments described above include various inventions, and various inventions can be extracted by a combination selected from a plurality of disclosed components. For example, even if some components are eliminated from all the components described in the embodiments, in a case where the problem can be solved and the advantageous effects can be obtained, a configuration from which the components are eliminated can be extracted as an invention.

### REFERENCE SIGNS LIST

10 information presentation device
10a scenario control device
10b presentation control device
20 control unit
21 scenario acquisition unit
22 operation content acquisition unit
23 execution range setting unit
24 execution level setting unit
25 execution scenario determination unit
26 operation result output unit
31 execution scenario acquisition unit
32 instruction output unit
33 execution position notification unit
40 storage unit
41 scenario storage unit
50 input/output interface
60 input device
70 scenario operation device
71 operation screen
72 setting window
73 slide window
74 check box
76 setting window
78 execution button
80 proxy device
80A virtual agent
80B robot
91 CPU
92 RAM
93 ROM
94 auxiliary storage device
95 bus

1. An information presentation method, comprising:
acquiring a scenario of a presentation;
acquiring an operation content for the scenario;
determining an execution scenario on a basis of the scenario and the operation content;
outputting an instruction for an action according to the execution scenario to a proxy device; and
outputting a display instruction for causing a display of a current execution content of the execution scenario.

2. The information presentation method according to claim 1, further comprising:
setting an execution range of the scenario on the basis of the operation content; and
setting an execution level of the scenario on the basis of the operation content,
wherein the determining the execution scenario determines the execution scenario on a basis of the execution range and the execution level.

3. The information presentation method according to claim 2, wherein the setting the execution level sets, on the basis of the operation content, any one of:
an outline reproduction level for reproducing only a main action in the scenario,
a simple reproduction level for reproducing an action in the scenario as it is, and
an emphasis reproduction level for emphasizing and reproducing a characteristic action in the scenario,
as the execution level.

4. The information presentation method according to claim 3, wherein:
the determining the execution scenario determines only a non-verbal action associated with a longest utterance action as a non-verbal action of the execution scenario in a case where the execution level is the outline reproduction level.

5. The information presentation method according to claim 3, wherein:
the determining the execution scenario divides a non-verbal action that is most frequently used and determines a divided non-verbal action as a non-verbal action of the execution scenario in a case where the execution level is the outline reproduction level.

6. An information presentation device, comprising:
scenario acquisition circuitry configured to acquire a scenario;
operation content acquisition circuitry configured to acquire an operation content for the scenario;
execution scenario determination circuitry configured to determine an execution scenario on a basis of the scenario and the operation content;
instruction output circuitry configured to output an instruction for an action according to the execution scenario to a proxy device; and
operation result output circuitry configured to output a display instruction for causing a display to display a current execution content of the execution scenario.

7. A non-transitory computer readable medium storing an information presentation program for causing a computer to execute processing of the information presentation method according to claim 1.

8. The information presentation device according to claim 1, further comprising:
circuitry configured to set an execution range of the scenario on the basis of the operation content; and
circuitry configured to set an execution level of the scenario on the basis of the operation content,
wherein execution scenario determination circuitry determines the execution scenario on a basis of the execution range and the execution level.

9. The information presentation device according to claim 8, wherein the circuitry configured to set an execution level sets, on the basis of the operation content, any one of:
an outline reproduction level for reproducing only a main action in the scenario,
a simple reproduction level for reproducing an action in the scenario as it is, and
an emphasis reproduction level for emphasizing and reproducing a characteristic action in the scenario,
as the execution level.

10. The information presentation device according to claim 9, wherein:
the execution scenario determination circuitry determines only a non-verbal action associated with a longest utterance action as a non-verbal action of the execution scenario in a case where the execution level is the outline reproduction level.

11. The information presentation device according to claim 9, wherein:
the execution scenario determination circuitry divides a non-verbal action that is most frequently used and determines a divided non-verbal action as a non-verbal action of the execution scenario in a case where the execution level is the outline reproduction level.
